(19) United States
(12) Patent Application Publication
(10) Pub. No.: US 2009/0187493 A1
(43) Pub. Date: Jul. 23, 2009

(54) Method for offsetting carbon dioxide emissions associated with shipping

(76) Inventor: Ken Whiteman, Hood River, OR (US)

Correspondence Address: Ken Whiteman, 316 Montello Ave, Hood River, OR, 97031, US

(21) Appl. No.: 12/319,849

(22) Filed: Jan. 13, 2009

Related U.S. Application Data
(60) Provisional application No. 61/011,490, filed on Jan. 17, 2008.

(51) Int. Cl. G06Q 10/00; G06Q 99/00

(52) U.S. Cl. 705/28; 705/1

(57) ABSTRACT

The invention is a method that provides consumers and retailers an easy way to track shipments, use shipment information (e.g. tracking information) to accurately calculate carbon dioxide emissions generated by the shipment, and provide a means to offset the carbon dioxide emission either before or after the shipment takes place.

### FIELD OF THE INVENTION

This invention relates generally to methods and systems for offsetting the carbon dioxide generated by shipping packages. More particularly, the methods and systems of the invention provide a convenient means for retailers and customers to quickly and accurately calculate the carbon dioxide emissions associated with given transactions and to offer direct options to compensate for the generated emissions.

### BACKGROUND

Shopping methods that utilize the postal service or other private party shipping companies have long offered a convenient means for customers to access a wide variety of goods. Historically, catalogs and mailings have provided the primary method for shoppers to select from desired merchandise. More recently, the growth of the Internet has spawned a proliferation of retailers that utilize the tools available through the World Wide Web to broker on-line transactions with customers distributed throughout the globe.

Unfortunately, one drawback associated with these retail transactions is the need to ship the purchased goods to the buyer. Although numerous services exist that are able to ship packages around the world with varying degrees of expense and rapidity, all have an associated cost in the form of carbon dioxide and other greenhouse gases that are generated during the shipping process. As greater information linking the generation of these gases to the problem of climate change and global warming, there is an associated need to provide both retailers and customers with a means for compensating for the gases generated during shipping. This invention satisfies these and other needs.

### SUMMARY OF THE INVENTION

The invention is a method that provides consumers and retailers an easy way to track shipments, use shipment information (e.g. tracking information) to accurately calculate carbon dioxide emissions generated by the shipment, and provide a means to offset the carbon dioxide emission either before or after the shipment takes place. The invention also includes systems of computers linked over local and wide area networks that are programmed to perform the methods of carbon dioxide offsetting.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a schematic representation of a method for presenting carbon offsets to customers, according to the invention;

FIG. 2 is a schematic representation of a method for purchasing carbon offsets, according to the invention;

FIG. 3 is a schematic representation of a retailer initiated carbon offset transaction, according to the invention;

FIG. 4 is a schematic representation of a consumer direct method for purchasing carbon offsets, according to the invention;

FIG. 5 is a schematic representation of a method for consolidating shipment information, according to the invention;

FIG. 6 is a schematic representation of a method for automatically consolidating shipment information, according to the invention;

FIG. 7 is a schematic representation of an account creation process, according to the invention;

FIG. 8 is a schematic representation of a carbon offset calculation subroutine, according to the invention;

FIG. 9 is a schematic representation of a method for configuring a shipper account for automatic tracking number extraction, according to the invention;

FIG. 10 is a schematic representation of a method for automatically extracting tracking number information, according to the invention;

FIG. 11 is a schematic representation of an automated method for providing shipment offset using SPAM filtering, according to the invention; and

FIG. 12 is a schematic representation of an automated method for providing shipment offset using temporary email addresses, according to the invention;

### DETAILED DESCRIPTION OF THE INVENTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

The invention includes systems and methods that provide consumers and retailers an easy way to track shipments, use shipment information (e.g. tracking information) to accurately calculate carbon dioxide emissions generated by the shipment, and provide a means to offset the carbon dioxide emission either before or after the shipment takes place.

In one embodiment, the system of the invention includes three coordinated main components to create the shipping system. The components are 1) a Retailer Website—with a specialized software component; 2) Consumer Computer & Software; and 3) a Third Party Web Server (TPWS), interface software, database, and carbon offset calculation subroutine. In some embodiments, the system also includes a shipper web server and associated data feed containing shipment information. In other aspects of the invention, the TPWS can be considered a Shipping Offset Retailer (SOR).

The Retailer Website offers products and a shopping cart for processing customer purchases. A preferred version of the system includes a software component that resides on the retailer website for communicating with the TPWS. During the checkout process, the software component queries the TPWS with the starting and ending zip codes for the shipment, the customers' selected shipping method, the package weight, and/or the package dimensions. The software component then receives a result from the TPWS that contains the estimated CO₂ generated by the shipment and the price of carbon offsets required to nullify the generated CO₂. The software component then displays the information to the customer and provides them the option to purchase the carbon offset. Purchases of the offsets by the retailer can be transacted with the TWPS at the time of the customers' purchase, or on a periodic basis. This embodiment requires a significant level of integration with the retailer's website, but also offers the most seamless interface.

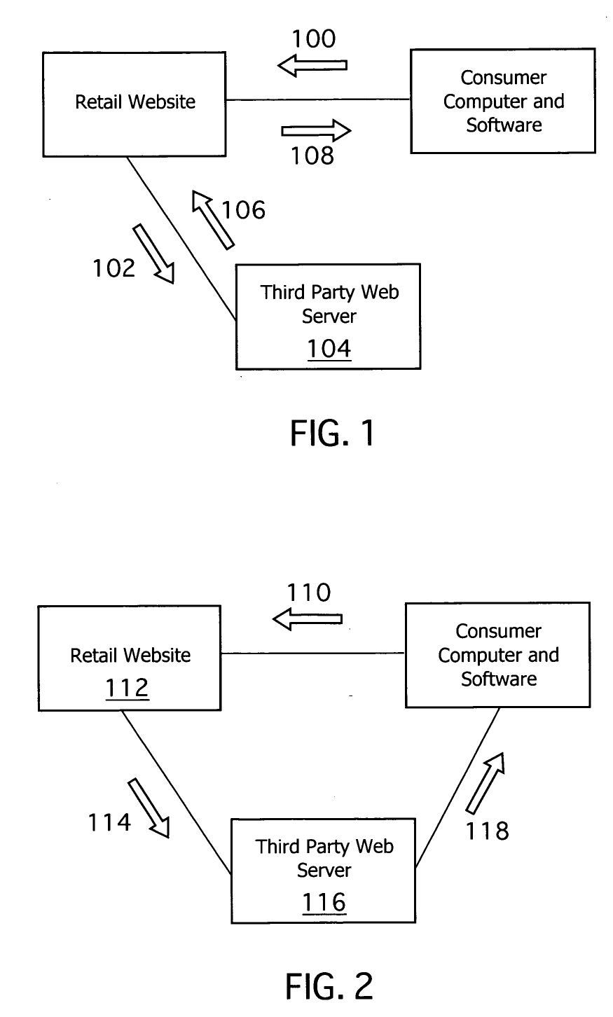

One aspect of this embodiment is shown in FIG. 1, which schematically represents a method for presenting carbon offsets to the customer. The buyer adds items to an on-line shopping cart in step 100. The retailer website then submits the carbon offset request to the TPWS in step 102. The TPWS calculates the carbon generated by the shipment and the corresponding offset in step 104 and returns the amount back to the retailer website in step 106. Finally, the retailer website displays the amount to the customer in step 108, offering the customer the opportunity to buy the offset.

FIG. 2, in turn, schematically illustrates a method for purchasing the calculated carbon offsets. In step 110, the buyer adds the calculated offset amount to the shopping cart and the retailer website charges the customer for the offset and the purchased item in step 112. In step 114, the payment, customer information and purchase information is sent to the TPWS. The TPWS purchases the carbon offset credit in step 116 and finally provides purchase confirmation to the customer or updates the customer's account in step 118.

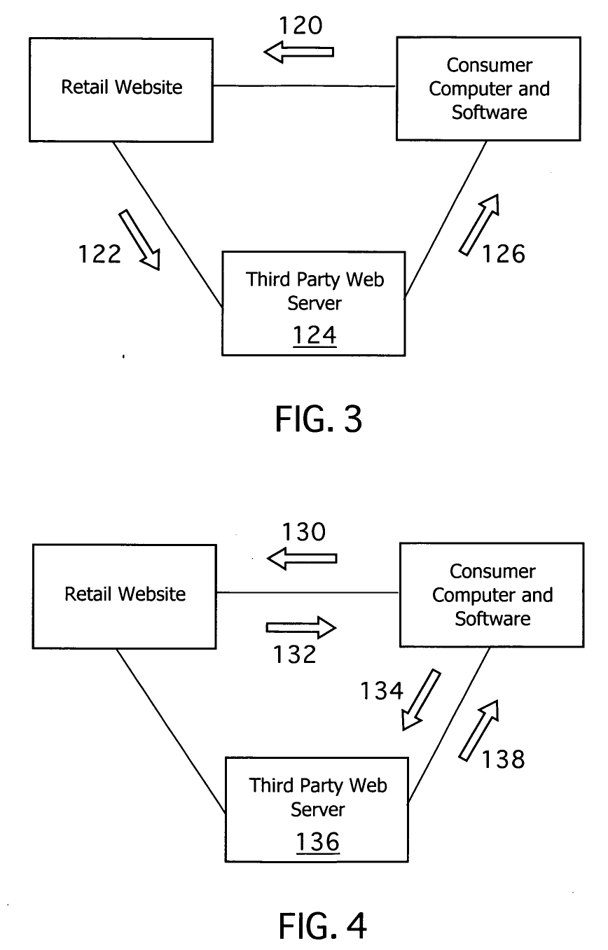

FIG. 3 schematically shows an embodiment of the invention in which the retailer initiates the offset transaction. In step 120, the buyer purchases an item and selects the TPWS shipping option to offset the carbon generated by the shipment. The retailer website provides the TPWS with the customer email address and shipment tracking information in step 122. The TPWS calculates the offset amount, identifies the customer account using the email address and purchases the offset by charging the customer's account in step 124. Finally, the TPWS confirms the offset purchase and provides shipment updates in step 126.

An alternate embodiment of the invention that, alternate minimize retailer involvement and allows the buyer to coordinate the offset transaction is shown schematically in FIG. 4. In step 130, the buyer purchases an item to be shipped from a retailer and receives tracking information regarding the shipment in step 132. The buyer then transmits the tracking information to the TPWS in step 134. The offset amount is calculated and the TPWS charges the buyer's account in step 136. Finally, the TPWS confirms the offset purchase and provides shipment updates to the buyer in step 138.

Another preferred version of the System includes a lighter version of the component and would be much easier to integrate to any type of shopping cart system. This version passes only the shipping information and a unique customer id for the transaction to the TPWS. The TPWS then manages the rest of the transaction, including the payment collection from the customer. The Retailer Website incorporates a means to select the carbon offset service provided by the TPWS for a given transaction. If the customer selects the offset service, the retailer website component transmits the package tracking number and the customer's login email address (or other unique customer identifier) to the TPWS once the package has shipped. That information is then be used by the TPWS to transact the purchase using the customers existing account information. If the customer does not have an account under the supplied email address, the TPWS sends the transaction and account creation instructions to the customer's email address. The customers' email address is then used to determine which TPWS account the shipment should be assigned to and the tracking information would be used to determine the details of the shipment for carbon generation calculations.

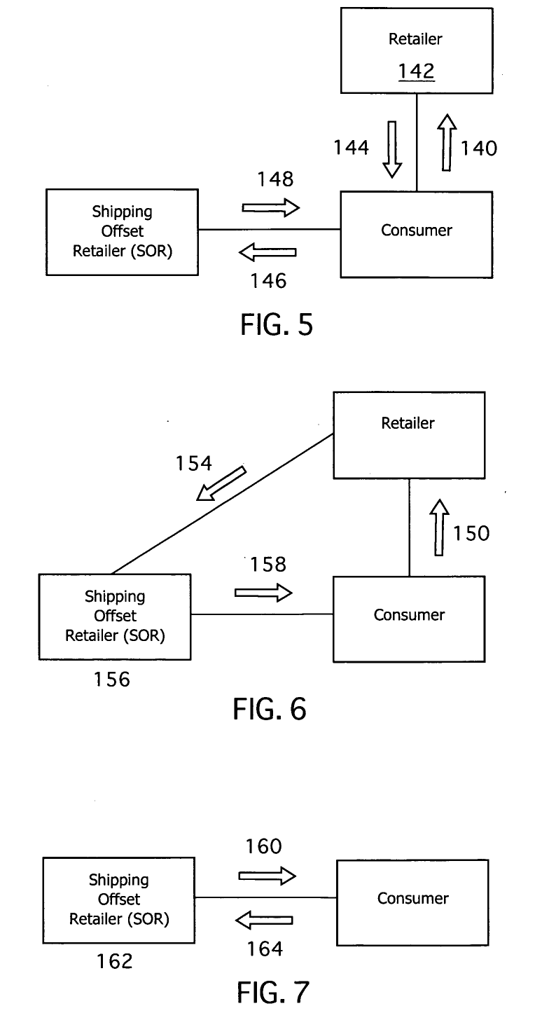

Examples of the above-noted embodiments are shown in FIGS. 5, 6 and 7. FIG. 5 schematically shows a method for manually consolidating shipment information without retailer involvement. In step 140, the consumer purchases an item and in step 142, the retailer ships the item. In step 144, the retailer emails tracking information regarding the shipment to the customer and the consumer sends the tracking information onto the SOR in step 146. The SOR then calculates the shipping impact, provides offset pricing, shipment status and an opportunity to purchase offsets to the consumer in step 148. A more automated method is shown schematically in FIG. 6, wherein the consumer purchases an item from the retailer and provides a dedicated email address in step 150. The retailer ships the product to the consumer in step 152 and emails order and tracking information to the SOR in step 154. The SOR extracts shipping information, stores the information, calculates offsets, and then either provides the consumer with the option of offsetting the shipment or conducts the offset purchase transaction automatically in step 156. Finally, the SOR forwards the original retailer email from step 154 to the consumer in step 158 as confirmation. The embodiment shown in FIG. 6 preferably involves an account creation process shown schematically in FIG. 7. In step 160, the consumer sends account information to the SOR and provides an email address. Next, the SOR creates an account for the consumer in step 162. Preferably, the SOR generates a local email address associated with the email address supplied by the consumer and stores the information in a database. Finally, the SOR sends the generated email address (or addresses) to the consumer in step 164 for use by the consumer when making future purchases involving shipments that can be offset. As will be appreciated, the use of the generated email address simplifies account management and minimizes the potential for SPAM abuses.

In the noted embodiment, the retailer, the consumer, or the shipping company is allowed to offset shipments by sending the shipment tracking numbers to the dedicated email address, associated with their TPWS account. The email address is unique to the TPWS account holder, and allows the account holder to forward emails containing tracking numbers to the TPWS where the emails are parsed, tracking numbers are extracted, and placed into the user's account. This embodiment also can include email filtering capabilities, such as an integrated pin number in the email address, from-address filtering capabilities within the users' accounts, and IP address filtering to prevent unauthorized emails from being accepted. To offset all shipments in a user's account, the user can use this embodiment to configure their shipper account (such as UPS, FedEx, or USPS) so that all shipments they make will generate an email to the TPWS email address upon shipment automatically. In that case, once the system is configured, it requires no further human intervention to offset shipments.

Another alternative to entering shipping information would involve the customer entering the detailed shipping information, such as, starting zip code, ending zip code, package dimension, package weight, shipment method, and shipping carrier. A means for such entries can be provided can be desirable when the tracking number and associated information is not available.

The system also includes a Third Party Web Server (TWS), which is the hub of the system of the invention. It provides a centralized location for calculating carbon generation, tracking shipments, transacting carbon offsets, storing transaction details, maintaining security, and for presenting status information to customers. The TPWS is comprised of an offset calculation subroutine for calculating carbon generation and associated offset requirements, an e-commerce engine for transacting carbon offset purchases, customized website code, and a database for storing information for later retrieval.

The TPWS includes a shipment tracking module that converts a shipment tracking number into an estimated distance and physical path of travel. This path varies by carrier and by shipment method. The shipment tracking module includes multiple methods of estimating the physical path and distance of travel. The preferred method is to use a tracking number to query the shipper about the package weight, dimensions, starting/ending zip codes, location of intermediate stopping points (such as transfer stations), the shipment method (air, ground, freight, boat, etc.), the shipment dates, and expected delivery time. The tracking module also includes an offset calculation subroutine to analyze the transit velocity for each leg to determine the likely trasportation method used for each leg of the shipments (air, truck, etc.). The resulting information is fed into the offset calculation subroutine to calculate carbon consumption and carbon offset credits required to offset the carbon generated. The optimal transit path can then be displayed to the customer in the form of a map with a path overlay so they can easily see where the packages are in the shipping process.

An alternate method of determining distance and physical path uses the starting and ending zip codes to generate an approximate path. The calculation is detailed below.

The systems and methods of the invention preferably use an algorithm to calculate the distance and most likely path that a package travels, starting at the shipper and ending at the receiver. The distance is calculated in one or more ways. In one preferred embodiment, the distance is calculated by using the starting zip code of the shipment, the intermediate zip codes for locations where the shipment stops along the way (such as shipment transfer locations), and the final zip code for delivery to feed into a mapping algorithm such as Google Maps. The resulting driving distance and the best path of travel is calculated to create a best estimate of actual distance traveled. In the case of an airplane transit leg, a straight line approximation of distance is used for higher accuracy. In an alternate embodiment, the starting and ending zip codes of the shipment are converted into geographical coordinates. The straight line distance between the coordinates, accounting for the curvature of the earth, is calculated as a first order approximation of distance. Based on actual shipments with similar geographical spacing, the actual miles driven, a table of typical multipliers for a given distance is generated. Those multipliers are multiplied by the calculated straight line distance to generate an approximation of the actual distance traveled for a given shipment.

The offset calculation subroutine then uses the package weight and/or package dimensions to calculate the amount of capacity of a given truck or airplane is used for the given package. The actual package weight and or dimensions is divided by the average cargo weight and/or cargo area of air cargo planes, tractor trailers, and delivery trucks to determine the usage percentage. The appropriate transport means is selected based on the type of shipment that is used (e.g. air or ground).

The per distance fuel consumption for each mode of transport is generated based on published values. The per fuel unit carbon dioxide release value is generated based on published values. Alternatively, a life-cycle carbon model can be used, accounting for the CO₂ impact from sources like the building and maintenance of roads, production of vehicles, gasoline refining, and other carbon generating processes related to shipping. These life-cycle carbon rates are typically published as pounds of CO₂ per ton-mile.

The path of the given shipment is important to calculate an accurate mileage for a particular shipment. Shipments are primarily made by air or by ground. Air shipments tend happen in a direct, point-to-point manner. Most air shipments use a centralized hub where packages all come together in once place and are then routed to their final destination. The offset calculation subroutine calculates air shipment distances accordingly. Ground shipments, on the other hand, are typically made using the highway infrastructure. A point to point method of distance is sub-optimal in this case. Most ground shipments are routed to a series of transfer stations where the packages are transferred from truck to truck. In this case, the most optimal distance calculation is to use actual driving directions that truck drivers might use to get from point to point. Mapping tools or driving distance databases are used to calculate distance and path information from point to point. The offset calculation subroutine uses this method between each point of travel for the entire shipment path.

In consideration of the different methods of shipment, the offset calculation subroutine and associated software displays the path to the customer that is the most likely path of the shipment. This path is displayed with lines superimposed over a map. The map can be generated mid-shipment to illustrate the status and location of the package. It can also be generated post shipment to illustrate the path that was taken.

Preferably, the offset calculation subroutine then combines the above intermediate variables to generate the output variables including total distance shipped, allocated carbon dioxide generation for the package delivery, and the price of carbon dioxide offset certificates to offset the generated amount of carbon

Intermediate results of the offset calculation subroutine can be cached and later recalled to speed up the execution of the offset calculation subroutine. Because the same transfer stations are often used from shipment to shipment, the shipment routing is often similar.

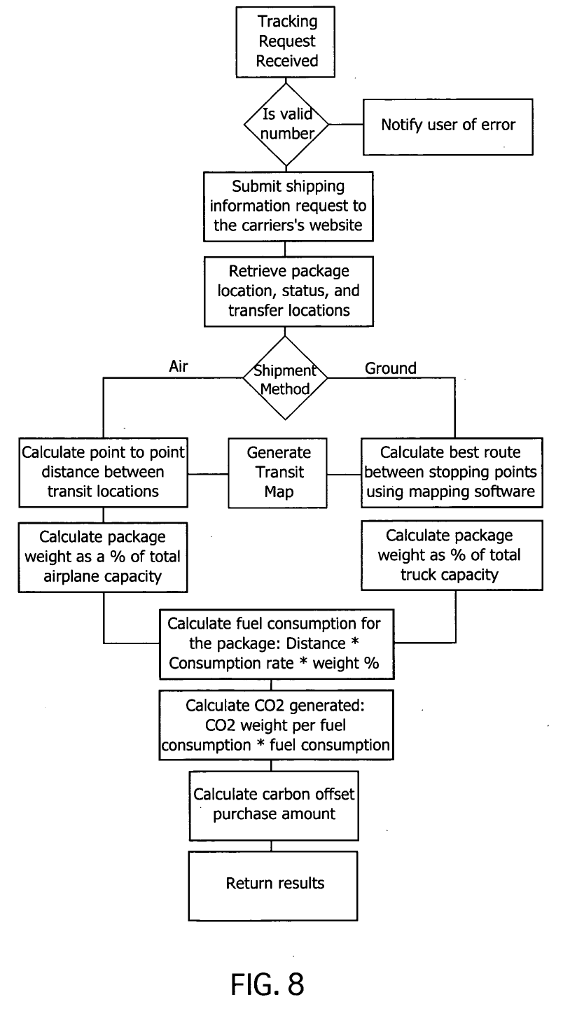

FIG. 8 shows a flow chart illustrating the interrelation of the major elements of the offset calculation subroutine.

In a further embodiment of the invention, the system includes an E-Commerce module configured to allow customers and retailers to purchase carbon credits to offset their shipments. The module can transact shipments individually or can bundle them and transact them in groups. The module allows the TPWS to automatically purchase carbon offsets from the Carbon Offset Retailer, who may be the same party as the TPWS owner.

As discussed above, preferred embodiments of the invention include a database used to store and retrieve customer, shipment, and purchase information.

Further embodiments of the system include a Carbon Offset Retailer (COR), offering carbon offsets. Carbon offsets are purchased from the COR by the TPWS. These purchases can be made after each customer transaction, or they can be stored and transacted in groups. Transacting in groups allows the overhead to be reduced and also reduces any per transaction costs. The System also includes a tax deductibility feature. This feature tracks the purchases that a customer makes over the tax year. At the end of the tax year, the customer can be provided with a tax deduction report. The report can be generated in coordination with the COR for traceability.

A significant challenge in creating a seamless shipment offsetting system is the collection of tracking numbers. This invention offers several ways to collect tracking numbers for shipments. To maximize the use of this invention, it must be simple to use with as little manual intervention as possible. This invention includes several means to accomplish this.

This system allows a business or consumer to configure their shipping account so that every shipment they make is automatically added to their TPWS account for offsetting. When signing up for a TPWS account, the account holder is assigned one or more email addresses associated with the TPWS server. Any emails that are sent to those addresses are scanned for tracking numbers, which are automatically entered into the account holder's TPWS account. To configure a shipper account to automatically offset all shipments, the account owner configures their shipping account to send tracking emails to their account address. Once configured, shipment offsets can be made automatically for all future shipments.

To prevent spammers and other unauthorized users from sending tracking numbers into other users' accounts by email, the email tracking system can be configured to use a pin number that is integral to their address. This makes guessing valid email addresses very difficult. Also, by giving the account holder the ability to define authorized from-addresses, all emails from non-approved addresses can be discarded. To validate that the from-address is coming from a known location, IP address filtering can be used to verify that the email originated at a known and trusted location.

The systems and methods also allow automating the collection of shipment information. When purchasing items from retailers who do not use carbon offsetting of shipments, the purchaser may wish to offset the shipment on their own. To make this as simple as possible, an extension to the email system can be used. In this case, the TPWS account holder can configure their account to forward all incoming email on their TPWS account email address to their own personal address after being scanned for shipment tracking numbers. By using their TPWS account email address when making purchases online, all purchase related information, including tracking numbers will be sent to the TPWS email address first before being forwarded to the account holder.

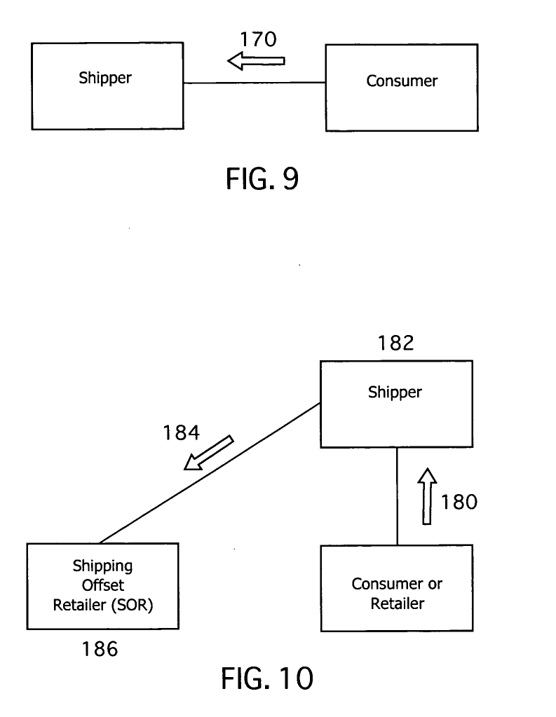

Examples of the noted embodiments are shown in FIGS. 9 and 10. FIG. 9 schematically shows the method for a consumer manually configuring a shipper account for tracking number extraction. In step 170, the consumer configures the shipping account to send tracking emails to a personalized SOR email address. The configuration can apply to all shipments or for a single shipment at a time. FIG. 10 schematically shows extraction of the shipping information from the shipper. In step 180, the consumer or retailer initiates a shipment through their shipper account which is configured to send shipment tracking emails to their personalized SOR email address. In step 182, the shipper ships the package for the consumer or retailer. In step 184, shipment emails are sent to the SOR containing each shipment tracking number. Finally, in step 186, the SOR extracts shipping information from the tracking numbers, calculates the associated offsets and either provides the option to purchase offsets or conducts the offset transaction automatically.

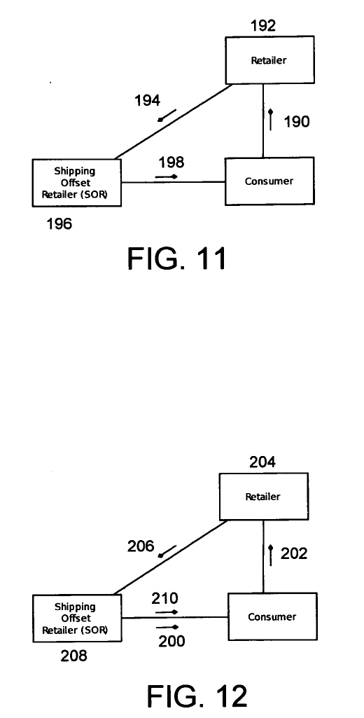

In this case, the customer receives the emails on their personal address as though they had used it to make the purchase, but the tracking numbers are automatically extracted in the process. SPAM filtering techniques can also protect the customer from receiving inappropriate emails. This is shown schematically in FIG. 11, wherein the consumer purchases an item using their SOR email address in step 190. The retailer ships the product in step 192 and transmits the order, email address and tracking information to the SOR in step 194. The SOR extracts shipping information and stores it, calculates the associated offset and either provides the option to purchase offsets or conducts the offset transaction automatically in step 196. Additionally, the SOR runs a SPAM filter on incoming email to identify SPAM emails, which are not forwarded to the consumer, but rather stored for later analysis or deleted. The SOR sends filtered retailer email on to the consumer in step 198.

Additionally, temporary TPWS email addresses can be assigned that can be turned off or set to expire to prevent future communications from the retailer. As shown schematically in FIG. 12, the SOR provides a temporary email to the consumer in step 200, allowing the consumer to purchase an item from the retailer using the temporary email in step 202. The retailer ships the product in step 204 and transmits the order, temporary email address and tracking information to the SOR in step 206. The SOR extracts shipping information and stores it, calculates the associated offset and either provides the option to purchase offsets or conducts the offset transaction automatically in step 208. Additionally, the SOR determines whether the temporary email address has expired. If so, the information can be stored for further review or deleted as desired. The SOR sends non-expired retailer email on to the consumer in step 210.

In yet another embodiment of the invention, the method relies on the TPWS account holder to manually forward emails containing tracking numbers to their TPWS email address. While it still requires manual intervention for each shipment, it is easier than navigating to a website and entering the tracking numbers manually.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. The present embodiments are to be considered as illustrative and not restrictive, and the invention is not to be limited to the details given herein. It is therefore intended that the disclosure and following claims be interpreted as covering all such alterations and modifications as fall within the true spirit and scope of the invention.

What is claimed is:

1. A method for offsetting carbon dioxide emissions associated with shipping a package comprising the steps of receiving tracking and shipment information associated with the package from a transaction between a consumer and a retailer; approximating a shipment distance and transport method from the tracking and shipment information; calculating carbon dioxide emissions associated with shipping the package on the basis of the approximated shipment distance and transport method; and providing a carbon offset option determined from the calculated carbon dioxide emissions.

2. A system for offsetting carbon dioxide emissions associated with shipping a package comprising a consumer computer, a retailer server and a offset server linked together via a wide area network; wherein the consumer computer, the retailer server and the offset server are configured so that the offset server receives tracking and shipment information associated with the package from a transaction conducted between the consumer computer and the retailer server; wherein the offset server is configured to approximate a shipment distance and transport method from the tracking and shipment information; wherein the offset server is configured to calculate carbon dioxide emissions associated with shipping the package on the basis of the approximated shipment distance and transport method; and wherein the offset server is configured to provide a carbon offset option determined from the calculated carbon dioxide emissions to the retail server or the consumer computer.

3. A method for offsetting carbon dioxide emissions associated with shipping a package comprising the steps of generating a personalized email address; receiving tracking and shipment information associated with the package and identified by the personalized email address from a transaction between a consumer and a retailer; approximating a shipment distance and transport method from the tracking and shipment information; calculating carbon dioxide emissions associated with shipping the package on the basis of the approximated shipment distance and transport method; and providing a carbon offset option determined from the calculated carbon dioxide emissions by transmitting the option to the personalized email address.
